(19) United States
(12) Patent Application Publication
(10) Pub. No.: US 2013/0091332 A1
(43) Pub. Date: Apr. 11, 2013

(54) OS-independent Framework and Software Library for Real Time Inter-process Data Transfer (Data River)

(71) Applicant: Andre Vankov, San Diego, CA (US)

(72) Inventor: Andre Vankov, San Diego, CA (US)

(21) Appl. No.: 13/253,885

(22) Filed: Oct. 5, 2011

(51) Int. Cl. G06F 12/00

(52) U.S. Cl. 711/153; 711/E12.001

(57) ABSTRACT

Proposed is a secure real-time inter-process data exchange mechanism based on memory mapped files (MMF). A modified FIFO access to the data (“one head, multiple tails”) is provided by pointers residing in a MMF buffer. A process writes to a data area of the buffer using “head” pointer, and data are read by processes using “tail” pointers. Only one shared data block is accessible at any given time, thus achieving secure high-performance real-time data sharing data between processes without using OS-dependent thread-synchronization techniques. The invention is implemented as OS-specific dynamic libraries that form a platform-independent software layer which hides the implementation details from the programmer. Access to the libraries is provided by a simple and easy to use API, via a limited number of high-level functions, with syntax consistent across languages (C, C++, Pascal, MATLAB) and OS platforms (Windows, Linux, MacOSX).

### CROSS-REFERENCES TO RELATED APPLICATIONS

n/a

### STATEMENT REGARDING FEDERALLY SPONSORED RESEARCH AND DEVELOPMENT

n/a

### REFERENCE TO SEQUENCE LISTING, A TABLE, OR A COMPUTER PROGRAM LISTING COMPACT DISK APPENDIX

n/a

### TECHNICAL FIELD

The invention relates to real-time Inter-Process Communications (IPC).

### BACKGROUND OF THE INVENTION

Sharing data between processes is an important function that allows great flexibility and modularity when developing software projects. All operating systems provide tools for IPC, a common one of them being the use of shared memory (ref.1-9), usually under the form of memory mapped files (MMF).

The protection of shared memory from being accessed simultaneously from more than one process and data corruption with potentially disastrous consequences typically involves the use of additional IPC mechanisms, such as named and unnamed kernel objects (semaphores, mutexes, critical sections, pipes, sockets, events, etc.) (ref.5, 6, 8). This adds a level of complexity in programming, which, in addition to being costly in terms of time investment, typically leads developers to limit themselves to mostly using IPC for inter-thread data transfer within a specific multi-threaded application, and rarely for data sharing between different applications.

Real-time applications, especially ones involving high volumes/rates of continuous data streams, add another level of performance requirements in terms of achieving timely and efficient data transfer between processes (ref.8).

Finally, the fact that the functionality of some of the synchronization objects differs across different OS platforms poses another challenge when developing applications that involve sharing memory between processes and targeting multiple OS (ref.4).

### SUMMARY OF THE INVENTION

The invention proposes a secure real-time data exchange mechanism based on memory mapped file (MMF) kernel objects. The proposed MMF-based data buffers (further referred to a “DataRiver buffers”) are structured as shared memory blocks, each one consisting of a header area and a data area. A modified First-In-First-Out (FIFO) type of access to the data (“one head, multiple tails”) is provided via a set of pointers residing in the header area of the MMF buffer. For any particular DataRiver buffer, one “server” process contributes (writes) data to the data area of the buffer using a “head” pointer, and a plurality of “client” processes receive (read) the data via individual “tail” pointers. As only one “head” or “tail” pointer and the data it is pointing to are accessible to a particular process at any given time, there is no possibility of simultaneous read and write access to the same block of shared data from any two processes. This makes unnecessary the use of additional thread-synchronization techniques, such as mutexes, semaphores, critical sections, pipes, etc, many of which are OS-specific; thus, a secure high-performance real-time method for sharing data between processes is achieved. As a result, because MMF files are supported by all operating systems, it is possible to implement the said secure high-performance real-time method for sharing data between processes as dynamic link libraries (shared objects), with specific embodiments for each OS (e.g., datariver.dll for Windows, datariver.so for Linux, datariver.dylib for Mac OS X), but sharing a common simple Application Programming Interface (API) thus serving as a platform-independent software layer that hides the implementation details from the end user, while providing a reliable and easy to use interface. The API to the real-time MMF-based buffers is implemented as a limited number of high level functions and are accessible from many computer languages (C, C++, Pascal, MATLAB, etc.) across all major OS platforms (Windows, Mac OS X, and Linux).

### DESCRIPTION OF THE DRAWINGS

FIG. 1 depicts a diagram of a DataRiver buffer.

FIG. 2 depicts a datagram.

FIG. 3 depicts an example for writing to a DataRiver buffer and reading from a DataRiver buffer using multiple tails.

### DETAILED DESCRIPTION OF THE INVENTION

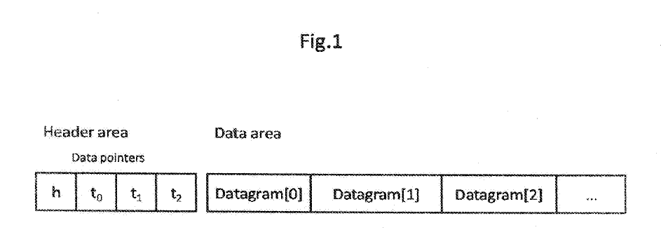

The invention proposes a method for OS-independent real-time framework for safe inter-process data exchange, implemented as MMF (memory-mapped file) buffers, specifically referred to further as DataRiver buffers, and embodied as a software library with a unified API (Application Programming Interface) across different computer languages and platforms. The DataRiver buffer consists of two areas: header area and data area. The data area of the buffer is allocated for the actual data; the header area contains data pointers that include a head pointer that points to where data will be placed, and an array of tail pointers that point to the data available for reading (FIG. 1).

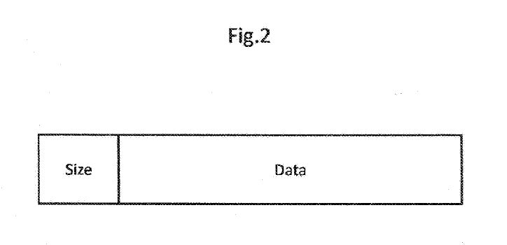

An actual datagram (defined as one contiguous piece of data in the data buffer) consists of a size field that contains the number of the bytes to follow, followed by the actual data (FIG. 2). When a datagram is written to the buffer, the current value of head is used to place the data; then the value is incremented by the size of the datagram. Thus the logical sequence is:
Write the size of the data to be written to the buffer at position, pointed to by the head pointer and increment the head pointer by the number of bytes just written;
Write data at position, pointed to by the head pointer;
Move the head pointer to point to where the next datagram will be written.

Reading from the buffer uses the value of a tail as a pointer to the next available datagram to read the number of bytes of data to follow; then the actual data are read and the tail value is incremented by the size of the datagram to point to the next datagram. The logical sequence is:
Read the data byte count from the size field of the datagram, pointed to by the tail pointer and increment the tail pointer by the number of bytes just read;
from the data field of the datagram, pointed to by the tail pointer;
Read that number of data bytes that follow from the data field of the datagram, now pointed to by the tail pointer;
Move the tail pointer to point to the next datagram.

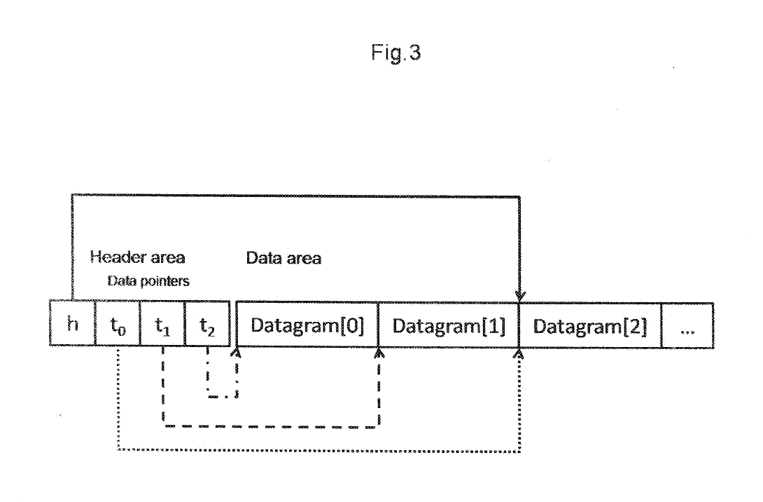

The datagram is not removed from the data area of the buffer, it just becomes inaccessible from the tail pointer that reads the data. As a number of tails are available, the same data can be accessed via a different tail (FIG. 3).

When the value of any tail pointer becomes the same as the value of the head pointer, this indicates that there is no data available for reading in the buffer.

### Inter-Process Synchronization Issues and their Resolution

Generally, when writing and reading occur in different threads (processes) asynchronously, conflicts may arise when a block of data is modified while being read, leading to compromising the data integrity. It is customary to use IPC synchronization objects such as semaphores, critical sections, mutexes, etc. to ensure that no other processes can access the target data during a transfer. The current invention uses a modified FIFO buffering mechanism (one head pointer, multiple tail pointers, each of them residing in the header area of the shared memory) to achieve secure data transfers, without using additional IPC mechanisms for IPC synchronization.

Avoiding write/write conflicts: In the proposed invention, writing to the data buffer is achieved via a head pointer that never points to data that is pointed to by any of the tail pointers that are used for reading data from the buffer. Since only one head pointer is used to write data to a data buffer, and it belongs to one and only one thread, there is no possibility for write/write conflict.

Avoiding write/read conflicts: In another scenario, each of the available the tail pointers can belong to different thread than the one writing to the buffer, thus making it probable that asynchronous reads may occur while data is being written to by the writing thread; however, due to the implemented sequence of updating the pointer positions, there is no possibility of the head pointer and any of the tail pointers pointing simultaneously to the same data block, thus avoiding any possibility for conflict.

Avoiding read/read conflicts: In a third scenario, it is possible for multiple threads to attempt to read data at the same time. However, since read access to buffered data is achieved via different independent tail pointers, and each one of them belongs to one and only one thread, there is no possibility of data corruption occurring during simultaneous reads.

The proposed method makes data transfers very fast, as it virtually eliminates the time when multithreading is blocked, and is particularly well suited for real-time applications. It also makes the ongoing thread synchronization completely transparent to the user, while ensuring great robustness and reliability of the inter-process communication.

Interfacing the OS-independent framework—the DataRiver library. In a particular embodiment the interface to the DataRiver buffers is implemented as a limited number of high level functions that reside in a dynamic link library (shared object) generically referred to as DataRiver (the specific name depends on the version and the operation system) and are accessible from any computer language that provides access to dynamic link libraries (.dll, .so, .dylib), e.g., C, C++, Pascal, MATLAB, etc., and platforms (Windows, Mac OS X, and Linux).

Access to the Data River buffers is provided by a set of high-level functions.

Opening and closing a DataRiver buffer is provided by the functions
DR_OPEN
DR_CLOSE

The function DR_OPEN creates a DataRiver buffer if one does not exist or opens an already existing one and returns a handle to it that is used as a calling parameter for the other functions to access the specific head or tail pointer.

The DR_CLOSE function releases the tail pointer previously allocated by the

DR _OPEN call, which makes it available for other processes.

Writing to the DataRiver buffers is provided by the function
DR_WRITE

The function DR_WRITE uses the head pointer, as described earlier to write a datagram to the DataRiver buffer, previously opened by DR_OPEN.

Reading from the DataRiver buffers is provided by the read-related functions
DR_READ
DR_PEEK

The DR_READ function reads an available datagram from the buffer and removes it from the buffer by advancing the corresponding tail pointer.

The DR_PEEK function reads an available datagram from the buffer but does not remove it from the buffer.

The syntax of the library functions is consistent across OS platforms and programming languages.

From any application, the programming logic is as follows:
Open a DataRiver buffer;
Write of read data;
Close the DataRiver buffer.

The DataRiver library is designed to be expandable to include new functions for data access and management as need arises.

1. A method to exchange data between processes based on using shared memory, which comprises a buffer (further referred to as “DataRiver buffer”) that consists of one contiguous memory block, subdivided into header area, which contains pointers to datagrams placed in a data area, each of which can be owned by one and only one thread, and are of two types—one head pointers, pointing to an area in the said data area where next datagram will be written to, and which is updated after the datagram has been written to the buffer, and multiple tail pointers, each pointing to a location in the said data area where datagram will be read from, each of which is advanced after a datagram has been read from the buffer.

2. A safe mechanism for IPC that is based on said method from claim 1 in which each of the said head and tail pointers of claim 1 is owned by one and only one thread and is advanced after each write operation (for the head pointer) or a read operation (for the tail pointers), which precludes the possibility of simultaneous read and write access to the same datagram from different threads, not necessitating the use of any other methods for IPC synchronization and thus capable of an exceptionally high real-time performance for sharing data between applications.

3. An embodiment of the said safe mechanism of data exchange of claim 2 that consists of an OS-independent software layer, based on memory mapped files, under the form of dynamic link library (shared object) that contains a limited number of high-level functions accessed through an API that is virtually identical across many computer languages/OS platforms.
